(19) United States
(12) Patent Application Publication
(10) Pub. No.: US 2009/0026117 A1
(43) Pub. Date: Jan. 29, 2009

(54) Method for sorting addressed mailings according to the destination address

(75) Inventors: Holger Paetsch, Zernsdorf (DE); Katja Worm, Berlin (DE); Georg Kinnemann, Bestensee (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 11/664,178

(22) PCT Filed: Sep. 7, 2005
(86) PCT No.: PCT/EP05/09585

§ 371 Date: Sep. 25, 2008

(30) Foreign Application Priority Data
Oct. 1, 2004 (DE) 10 2004 047 934.8

(51) Int. Cl. B07C 3/10; G06K 9/00

(52) U.S. Cl. 209/584; 382/101

(57) ABSTRACT

In the multistage sorting method, the mail items read in the first step are re-identified in the subsequent steps on the basis of characteristic features determined.

If unambiguous assignment to a plurality of candidates is not possible, reading steps are additionally carried out in the subsequent sorting steps and the partial reading results of the candidates are compared with the corresponding partial reading results of the first steps until unambiguous assignment is produced.

The invention relates to a method according to the preamble of claim 1.

Automatic sorting of mail items on the basis of the destination address takes place in a plurality of processing steps.

In the first step an image of the front of the item is recorded. An automatic reading system determines the position of the address block in the image, reads it using OCR technology and ascertains therefrom the required distribution information. The images of items that could not be read automatically are intercepted at a video coding station where they are manually coded.

In many sorting systems the distribution information is either printed directly onto the mail item or can be assigned from a database via a unique ID which is printed onto the item. In both cases the mail items are identified with the aid of machine-readable barcodes, thus enabling the distribution information once determined to be accessed in the subsequent processing steps.

The application and reading of this barcode requires some hardware complexity and is maintenance-intensive. In some case the imprinting of a barcode is not possible or not desirable.

In order to recognize mail items without applied IDs, a method has been disclosed which enables a mail item to be identified on the basis of characteristic features (known as fingerprints) obtained from the image (DE 40 00 603 C2). In order to simplify this identification technique in practice, a method has been described with which the search area for the identification of mail items is significantly limited (EP 1 222 037 B1).

The object of the invention is to create a method for sorting addressed mail items in a plurality of processing steps, wherein even in the case of mail items that are difficult to differentiate it is possible to identify them without applied ID codes with the aid of characteristic features in order to reduce the necessary reading complexity.

This object is achieved according to the invention by the features set forth in claim 1.

In the first processing step the relevant intermediate reading results are stored in the database together with the characteristic features, assigned thereto, as well as the read destination addresses/distribution information.

In the re-identification process of a further processing step, if there is no clear match of defined plausibility of the characteristic features determined in said processing step with a plurality of stored feature sets of found candidates from the first processing step, the automatic address reader for said further processing step is activated to read the address of the mail item currently to be re-identified.

The current intermediate reading results or reading results of the mail item to be identified are then compared with the corresponding stored intermediate reading results or reading results of the mail items of the feature candidates determined.

If a match of defined plausibility is found, the mail item assigned to this feature candidate with the stored distribution information of the destination address constitutes the re-identified mail item and sorting takes place on the basis of this distribution information.

This makes it possible, if there are a plurality of feature candidates for which no unambiguous selection of a single candidate merely on the basis of the feature comparisons is possible and which would therefore hitherto have had to be manually re-coded, for the majority to be processed automatically.

Advantageous embodiments of the invention are set forth in the sub-claims.

It is advantageous to perform the reading and comparison operation stepwise in the re-identification process of a further processing step according to the successive reading steps, the subsequent reading and comparison step only taking place if the preceding step yields no unambiguous candidate assignment. This means that the reading and comparison complexity is no greater than absolutely necessary.

For this purpose it is advantageous to proceed in the following sequence:

After activation of the automatic address reader and after determination of the address region of the destination address, this region is compared with the address regions for the feature candidates. If there is a match of defined plausibility with just one of the address regions, the associated mail item is identified and the reading process is terminated. If assignment to a single feature set is not possible, the individual characters and words are read and a comparison with the individual characters and words for the remaining feature candidates is performed. In the event of match of defined plausibility with the individual characters and words of just one feature candidate, the associated mail item is identified and the reading process is terminated. If assignment to a single feature set is still not possible, address interpretation is performed, the results of which are then compared with those of the remaining feature candidates. In the event of a match of defined plausibility with the address interpretation results for a single feature candidate, the associated mail item is identified and the reading process is terminated.

In this case it is advantageous, if primary and secondary readers are present in the address reader which are activated consecutively as required, to carry out the sequence described in the foregoing paragraph also using the secondary reader or readers during the re-identification process if automatic identification has not yet been achieved using the primary reader.

To enable the necessary storage requirement to be limited, it is advantageous to delete characteristic features stored in the database with the intermediate reading results and reading results/distribution codes when a particular decay time has been exceeded or the last processing step has been completed.

It is also advantageous, if automatic identification has not been completed successfully, to code only the images or address alternatives of the mail item candidates manually at video coding stations by means of selection, thereby minimizing the coding complexity.

The invention will now be explained in detail in an exemplary embodiment with reference to the accompanying drawings in which:

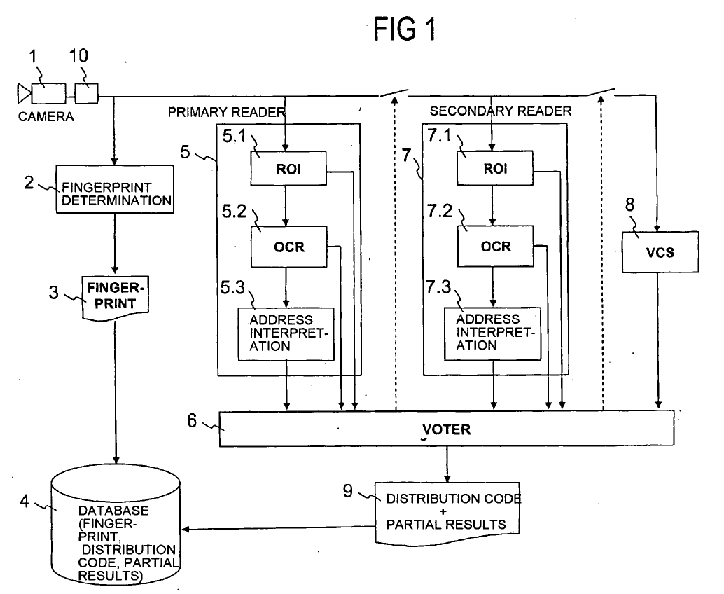

FIG. 1 shows a schematic structural representation of the first processing step,

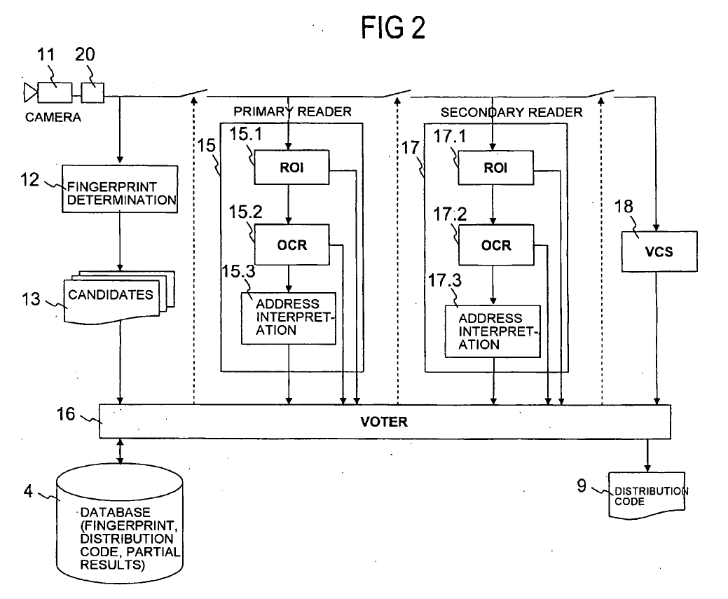

FIG. 2 shows a schematic structural representation of a further processing step,

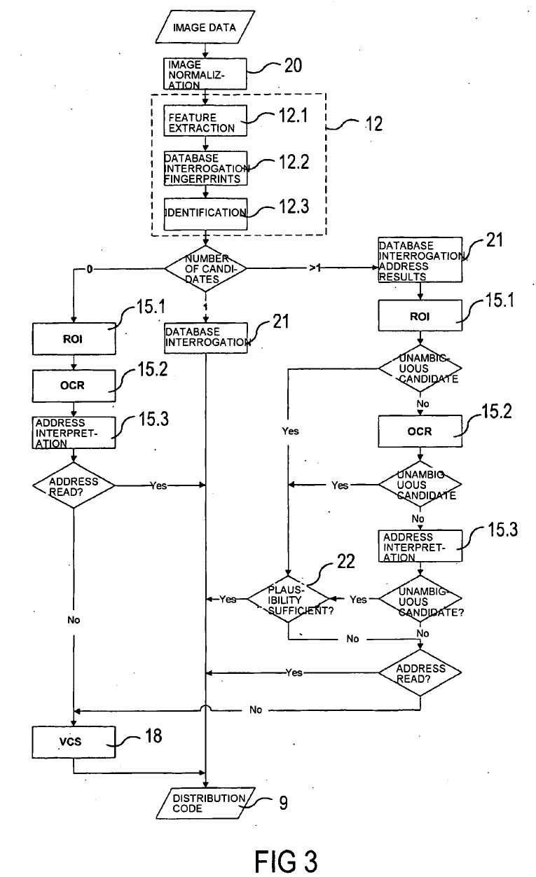

FIG. 3 shows a flowchart of the method sequence.

The fingerprinting method comprises, in the first processing step after image capture with a camera 1 and pre-processing 10 to create defined aspect ratios, the steps of feature extraction 2 (determining the characteristic features 3), determination of the distribution information in a reading process and storage of this data 3,9 including the intermediate results of the reading process in a database 4.

During pre-processing, which is shown in FIG. 3, various image normalization steps 10 are carried out. These include rotational position normalization, which corrects slight deviations in the rotational position of the mail items, and normalization to compensate for specific camera characteristics. In the case of grayscale images, this could be brightness normalization. This area also includes any binarization carried out.

Then in addition to global features such as mail item size, significant features are extracted from the pre-processed image 2, it being possible for structural features, histogram-based features and features derived from transformations (Fourier, cosine transformation, wavelets) to be used. In particular, features derived from the franking and address block are used as structural features, as these are even now machine processed. For the address block, for example, maximally stable features are used, such as the number of lines and the breakdown of the lines into words and characters.

For a specific use, the exact combination of the feature vectors used will be tailored to a significant sample of mail item images in order to achieve optimum recognition results.

The destination address is then read using a primary reader 5. First the region of the destination address (ROI) is determined 5.1, then the characters of the destination address are read with the OCR section 5.2 and, as a final step, address interpretation is performed with the aid of an address dictionary 5.3. The result is then either a read, verified and unambiguous address or there was no unambiguous result and a second reading attempt is initiated in a secondary reader 7 using different reading software. This involves the same processing steps, i.e. determining the ROI 7.1, reading the destination address 7.2 and performing address interpretation 7.3. If there is still no unambiguous result, video coding 8 is performed. The characteristic feature set/feature vector 3 of the relevant mail item and, assigned thereto, the reading results and intermediate reading results 9 are then present after storage in the database 4.

In the re-identification process, after image capture by means of a camera 11, for fingerprint recognition 12 there likewise take place pre-processing 20 of the image data, feature extraction 12.1 and storage of the feature vector. A comparison 12.2,12.3 is then performed with the feature vectors present in the database 4. In order to be able to identify a mail item efficiently on the basis of a feature vector/fingerprint determined, in the case of large datasets space partitioning techniques are used to determine the nearest neighbor. These enable the adjacent candidates in feature space to be quickly found and also allow the set of candidates currently to be considered to be efficiently managed. This aspect acquires particular importance for the fingerprinting method, as the reference set is subject to continuous change due to newly arriving mail items and completely processed mail items.

If the comparison/database interrogation 12.2,12.3 has resulted in an unequivocal match with one of the stored feature vectors, the associated distribution information 9 is assigned to the relevant mail item and sorting can take place.

If absolutely no candidate could be determined from the stored feature vectors, a quite normal and known automatic reading process must be carried out, possibly using two readers 15,17, i.e. comprising the steps: ROI search 15.1,17.1, OCR character reading 15.2,17.2 and address interpretation 15.3,17.3. If the destination address cannot be unambiguously identified in this way, the mail item image is manually coded at a video coding station 18 so that the item can be coded.

For the case that a plurality of possible candidates 13 were determined from feature vectors/fingerprints 3, additional features are used by the address readers 15 or 17. Of interest here are the results obtained from the Region of Interest (ROI) search 15.1,17.1, provided that this information is not yet being used in the fingerprint itself, the individual character alternatives determined in the character reading process 15.2,17.2 and of course the results of address interpretation 15.3,17.3. It suffices, as shown in the flowchart (FIG. 3), if only the reading steps necessary for selecting the correct fingerprint candidate are successfully completed, the results obtained by the address reader/s 15,17 being compared with the information stored in the database 4 for the fingerprint candidates 13 and irrelevant candidates being discarded until only one candidate remains. The sequence including the comparison processes is determined in a so-called voter 16.

For example, only the dispatch line, i.e. zip code and city may have been automatically read by the reader. Using this information, however, the voter 16 can in many cases already select a mail item unambiguously from the fingerprint candidates 13. Video coding 18 of the missing parts of the address can then be dispensed with.

In addition, the voter 16 decides, on the basis of the plausibilities from the result of fingerprint determination and the reading process results and partial results used, whether the result has been determined with sufficient certainty 22. If this is not the case, the complete destination address must be automatically read or video coded.

For the sake of clarity, FIG. 3 shows the sequence using only one primary reader. If other secondary readers are present, the processes are carried out accordingly for these readers also.

1. (canceled)

2. The method of claim 7,
wherein the reading and comparison operation is carried out stepwise in the re-identification process, and wherein a subsequent reading and comparison step only takes place if the preceding step yields no unambiguous candidate assignment.

3. The method of claim 2,
wherein after initiation of the automatic reading process and after determination of an address region of the destination address, this region is compared with the address regions for the feature candidates,
wherein in the event of an unambiguous match of required plausibility with one of the address regions the associated mail item is identified and the reading process is terminated,
wherein if assignment to a single feature set is not possible, reading of the individual characters and words and comparison with the individual characters and words stored for the remaining feature candidates take place,
wherein in the event of a match of defined plausibility with the individual characters and words of a single feature candidate, the associated mail item is identified and the reading process is terminated,
wherein if assignment to a single feature set is not possible, address interpretation is performed, the results of which are then compared with the remaining feature candidates, and
wherein in the event of a match of defined plausibility with the address interpretation results for a single feature candidate the associated mail item is identified and the reading process is terminated.

4. The method of claim 3,
wherein the address readers possess primary readers and secondary readers which are activated consecutively as required, and wherein during the re-identification process the secondary reader is used if automatic identification cannot yet be achieved with the primary reader.

5. The method of claim 7,
further comprising deleting the sets of features stored in the database if one of a predetermined decay time has been exceeded and the last processing step has been completed.

6. The method of claim 7,
wherein, if an automatic identification has not been completed successfully, only one of the images and address alternatives of the mail item candidates are manually coded at video coding stations by means of selection.

7. A method for sorting addressed mail items by destination address, comprising:
performing a first processing step, comprising:
recording an image of a mail item;
reading a destination address from the recorded image using an automatic reading process;
determining distribution information and characteristic features of the image;
storing the distribution information together with a set of features assigned to the mail item in a database, wherein the set of features includes the characteristic features of the image, intermediate reading results of the automatic reading process; and
performing in a further processing step a re-identification process for a current mail item, comprising:
recording an image of the current mail item;
determining characteristic features of the image of the current mail item;
determining candidates by comparing a current set of features, which includes the characteristic features of the image of the current mail item, with the set of features determined in the first processing step;
assigning to the current mail item the distribution information stored in the first processing step, if the current set of features matches with a predetermined plausibility a stored set of features unambiguously assigned to a candidate for a mail item;
activating the automatic reading process to read the address of the current mail item, if no clear match with the predetermined plausibility results;
comparing one of intermediate reading results and reading results determined by the reading of the address of the current mail item with one of corresponding intermediate reading results and reading results stored for previously determined candidates;
assigning to the current mail item distribution information stored for a previously determined candidate, if said comparing results in a match; and
sorting the current mail item according to the assigned distribution information.
